(19) United States
(12) Patent Application Publication
(10) Pub. No.: US 2025/0065633 A1
(43) Pub. Date: Feb. 27, 2025

(54) Tempering Device and Method for Tempering Ink for an Ink Printer

(71) Applicant: Canon Production Printing Holding B.V., Venlo (NL)

(72) Inventors: Florian Hitzlsperger, Poing (DE); Christoph Rummelsberger, Ismaning (DE); Ulrich Stöckle, Germering (DE); Arjan van der Bos, Beuningen (NL); Jeroen Cox, Roermond (NL)

(21) Appl. No.: 18/813,317

(22) Filed: Aug. 23, 2024

(30) Foreign Application Priority Data
Aug. 24, 2023 (DE) 10 2023 122 685.1

(51) Int. Cl. B41J 2/175; B41J 2/195; B41J 29/377; G05D 23/13; G05D 23/19

(52) U.S. Cl. CPC B41J 2/175; B41J 2/195; B41J 29/377; G05D 23/1333; G05D 23/1904

(57) ABSTRACT

A tempering device has a warm fluid source and a cold fluid source with different temperature levels. The two tempering fluids are supplied to a mixer that, from the two tempering fluids of different temperatures, mixes a mixture with desired temperature with the aid of a regulation device. The mixer is supplied to a heat exchanger. In the heat exchanger, the heat of the mixture fluid is transferred to the ink in order to temper the ink. The desired nominal temperature of the ink is regulated in that the ink temperature is measured after the heat exchanger and is fed back as a real value to the mixer, and the mixture temperature is thereby modified as necessary. The ink tempered in such a manner is supplied to a printing unit of the ink printer for printing to a printing substrate.

### CROSS-REFERENCE TO RELATED APPLICATION

This application claims priority to German Patent Application No. 10 2023 122 685.1 filed Aug. 24, 2023, the disclosure of which is hereby incorporated by reference in its entirety.

### BACKGROUND OF THE INVENTION

### Field of the Invention

The invention relates to a tempering device for tempering ink for a high-capacity ink printer. The invention also relates to a method for tempering ink for a high-capacity ink printer.

### Field of the Invention

Ink printers can be used for single-color or multicolor printing to a recording medium made from the most varied materials, for example paper. The design of such ink printing apparatuses is sufficiently known. In particular, digital high-speed ink printers are known in which, to generate a print image, ink droplets are ejected from nozzles of a print head of a printing unit onto a rapidly moving recording medium.

Such high-capacity ink printers should be capable of printing with high print quality. Different ambient temperatures can, of course, prevail at the installation site of the ink printer, which ambient temperatures may, of course, also change during operation. The ambient temperature at the site of the ink printer can feasibly be between 15° and 45° C., which can possibly influence the components of the ink printer, for example the ink, and therewith can negatively affect the print quality. For a high print quality, there is the need to maintain the ink at a correspondingly necessary operating temperature level, wherein only small temperature fluctuations within a narrow tolerance range of, for example, ±1° C. around the desired operating temperature of the ink should be tolerable.

From the disclosure of document DE 10 2007 043 644 A1, for printing machines a tempering apparatus is known that serves to temper defined parts or fluids of a rotary printing machine. A respective tempering agent circuit is hereby provided for cold water and warm water, the temperatures of which can be controlled and/or regulated independently of one another. In order to temper defined parts of the machine with a liquid, warm water and cold water are mixed accordingly until the desired temperature is achieved. The tempered mixture is then conducted in a consumption circuit directly to the corresponding parts in order to cool or preheat these. Unused liquid is respectively supplied back to corresponding liquid storages of the two tempering circuits via a return.

Instead of the hydraulic mixing of the two tempering agent circuits, a heat exchanger can also be connected with a consumption circuit of the printing machine, whereby the circuit runs are hydraulically separated from one another. The cold water circuit can thus, as a fountain solution, be in direct contact with the parts to be cooled. The cool fountain solution is then sprayed directly onto rollers of the printing machine for cooling.

A cooling device for rollers or print group cylinders for a printing machine is known from the patent document EP 1 870 238 Bl. A circuit to be tempered is fed from two loops of different temperature, depending on the external temperature. Rollers or printing cylinders can thus be cooled to below the ambient or external temperature. A heat exchanger can be thermally coupled directly to the component to be tempered in a supply circuit for supplying tempering agent of the desired temperature level. A mixture of both can additionally be fed as a tempering agent at a desired temperature level. All tempered print group cylinders, rollers etc. in the printing machine can thus be cooled via direct contact. The device also has heat recovery means via which energy from heat flows can be recovered for the purposes of heating the tempering agent storage.

Given the known tempering apparatuses, components of the printing machines are tempered directly by a mixture of the cooling agent and the heating agent, in that they come into contact with the mixture. It can thereby occur that the parts become too hot or too cold, in particular if a cooling/heating unit should fail. Ink could not be tempered with such a device, since the ink would be diluted with the cooling agent and would no longer be usable.

If ink is cooled or heated, for example with NTC thermistors or PTC thermistors, this may lead to the situation that the very sensitive ink is heated beyond its maximum allowable temperature (at which volatile substances in the ink vaporize) or freezes (viscosity can become too high) in the event of a malfunction. Since the newest inks are very temperature-sensitive, these should never be warmed above 45° C. Important constituents of the ink will already volatilize at such high temperatures. Local temperature elevations (hot spots) should also not be generated with electronic heating elements, since then the ink will become unusable, or at least a markedly degraded print image would be delivered and the print image would be starkly negatively affected, at least in regions.

### SUMMARY OF THE INVENTION

It is an object of the invention to achieve a tempering device and a method for tempering ink for an ink printer, given which the ink to be printed should be maintained at an optimally consistent and specified temperature during the printing.

This object is achieved for a tempering device via the features as described herein, and for a method via the features as described herein.

The tempering device has a warm fluid source and a cold fluid source that respectively provide at their outflow a tempering fluid with a higher (warm) fluid temperature or a lower (cold) fluid temperature. With the aid of a control or regulating device, a mixer mixes a mixture fluid from the two tempering fluids of different temperature, which mixture fluid provides a desired mixture temperature. The mixture fluid is supplied to a heat exchanger via an output of the mixer. The heat exchanger has a first fluid circuit with the mixture fluid, and separate therefrom a second fluid circuit with ink. In the heat exchanger, the ink is tempered by the mixture fluid to a desired nominal temperature. The ink tempered in such a way is supplied to a printing unit of the ink printer.

In a method for operating an ink tempering device for an ink printer having a tempering device, a warm tempering fluid and a cold tempering fluid are provided and supplied to a mixer. In the mixer, via a control/regulation the fractions of the two tempering fluids are mixed so that the temperature of a mixture fluid at the output of the mixer assumes a desired temperature. This mixture fluid is brought into thermal contact with ink in a heat exchanger in order to temper the ink to be printed to a desired operating temperature.

This device and this method have the advantage that the ink to be tempered is physically separate from the mixture fluid upon tempering and is thereby not “watered down.” If the higher temperature of the warm fluid (tempering fluid of the warm fluid source) is set so that it is always lower than the maximum allowable ink temperature, an overheating of the ink by the tempering device can be avoided even given a malfunction, since otherwise volatile components of the ink would be evaporated. The ink cannot thereby be damaged.

The cold fluid source with the lower temperature of the tempering fluid can thus also be set, in terms of its thermal level, so that it does not fall below the minimum allowable ink temperature so that—even given a malfunction—the ink cannot be overcooled, so that no components of the ink transition from a liquid state into the solid aggregate state, and the ink is therefore maintained in its desired consistency.

It is thus advantageous if the heat exchanger is a plate heat exchanger. Heat can then be transferred to the ink over a large area, and therefore rapidly, and the heat exchanger operates especially effectively.

The tempering fluids can be water to which possible additives are added so that, over time, no molds or other contaminants arise in the tempering fluids that would degrade the properties of the water as a tempering fluid. Water has the advantage that it is environmentally friendly and is available in sufficient quantity.

One or both fluid sources can be fed from the building water supply at the printer operator. The warm fluid source can thus be connected to a warm water tap, and the cold fluid source can be connected to a cold water tap. However, care should then be taken that the warm water temperature is not too hot and the cold water temperature is not too cold. If necessary, the water streams must themselves be pre-tempered.

The tempering device is thus of simple design, and no additional components—such as fluid reservoir, heating device, cooling device etc.—are required for this.

The fluid sources respectively have one or more temperature sensors to measure the fluid temperatures. Furthermore, temperature sensors that measure the respective fluid or ink temperatures can be arranged at the input of the mixer, at the output of the mixer, and at the output of the ink circuit at the heat exchanger.

It is particularly advantageous if a temperature sensor directly measures the temperature of the ink at or after the ink output, and returns the measured value as a control variable to the mixer, so that the mixture temperature can be controlled/regulated accordingly depending on the ink temperature. The temperature sensors advantageously measure the temperature of the fluid, or of the ink, directly in the fluid, and not externally at the fluid conduits or ink conduits. If the temperature sensor is coupled with the mixer for the purpose of feeding back the measured values, the temperature of the ink flowing out of the heat exchanger can then be regulated even better and more accurately with the aid of a control loop.

The fluid sources can accordingly have reservoirs in which the tempering fluid is stored and, if applicable, pre-tempered. Tempering fluid can be refilled or supplied from the outside at any time so that there is always sufficient tempering fluid in the respective fluid source. If connecting a corresponding fluid source to a water tap, the necessary quantity of water as tempering fluid can be supplied as needed at any time.

It is additionally advantageous if the warm fluid temperature (also referred to as a warm temperature) is set lower than or equal to the maximum allowable ink temperature. The ink then cannot be heated above this temperature—even accidentally. Conversely, it is advantageous if the cold fluid temperature (also referred to as a cold temperature) is set only so low that the ink temperature can in no event be tempered to below this temperature—even given a malfunction. Ideally, the warm fluid temperature and the cold fluid temperature are chosen so that a large adjustment range is created, and the desired nominal temperature of the ink is somewhere in a middle range between the two fluid temperatures. A simple and rapid regulation via a mixing of the two tempering fluids is thus possible.

If the control unit of the mixer is a PI controller (proportional-integral controller), the tempering fluids can be mixed rapidly and simply, corresponding to the respective quantity fractions, mixing valves controlled with said PI controller. The supplied tempering fluids are thereby mixed via corresponding inflow quantities, depending on the desired nominal temperature of the ink.

### BRIEF DESCRIPTION OF THE DRAWINGS

The terms Fig., Figs., Figure, and Figures are used interchangeably in the specification to refer to the corresponding figures in the drawings.

Exemplary embodiments of the invention are explained in detail in the following using schematic drawings. Shown are:

FIG. 1 a block diagram of a tempering device according to the invention, and

FIG. 2 a workflow diagram for a method for operating a tempering device for ink for an ink printer that has a tempering device according to FIG. 1.

### DESCRIPTION OF THE INVENTION

In the following, the invention is explained in detail using a plurality of exemplary embodiments of a tempering device for an ink printer, which here in a preferred exemplary embodiment is designed for four-color printing. Instead of ink, other liquid printer's colors can also be used (these are colorant-containing mixtures that are transferred onto a printing substrate with the aid of a printing form and are water-based or oil-based, with respective colorants within). Of course, more or fewer colors of inks or mixtures may also be used without deviating from the inventive ideas. Only the components that are significant and necessary for the functionality of the invention are explained in detail in Figures, and elements that are functionally the same or are identical are labeled with the same reference characters.

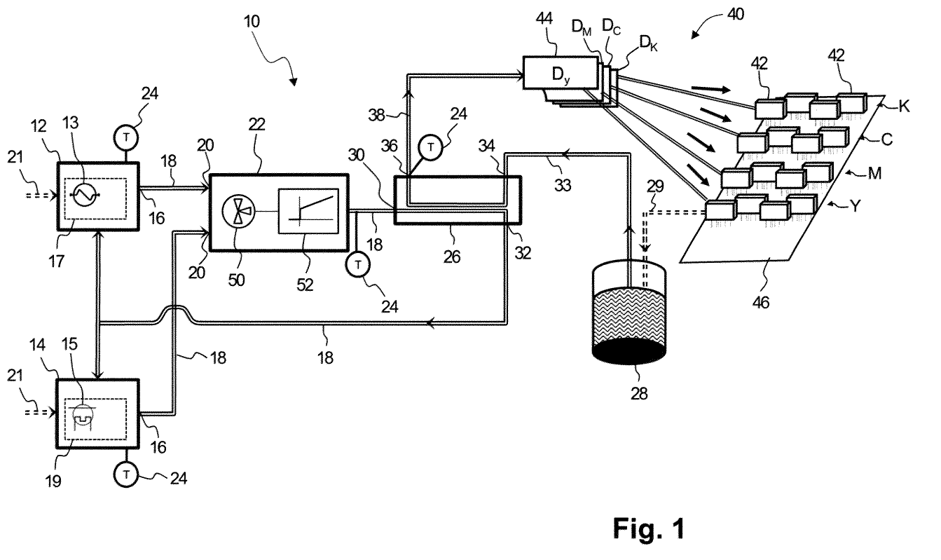

A first exemplary embodiment of a tempering device 10 for tempering ink for an ink printer is depicted in FIG. 1. The tempering device 10 has a warm fluid source 12 for a warm tempering fluid (also referred to here as a warm fluid) and a cold fluid source 14 for a cold tempering fluid (also referred to here as a cold fluid). In the warm fluid source 12, warm fluid is thereby available in a fluid reservoir 17 with a predetermined warm or upper temperature (also referred to as a warm temperature), whereas, in the cold fluid source 14, a cold fluid is available in a fluid reservoir 19 with a predetermined cold or lower temperature (also referred to as a cold temperature). The two fluid sources respectively have at least one outflow 16 as an output, which outflows 16 are connected via a respective fluid conduit 18 to inflows 20 to a mixer 22. For the operation of the ink printer, the warm fluid and the cold fluid are respectively brought to the warm temperature or cold temperature and largely held there during operation.

In the mixer 22, the two tempering fluids are mixed together in quantitative terms so that a mixture is created that exhibits, at the output 17 of the mixer 22, a mixture temperature resulting from the individual temperatures of the two tempering fluids. The mixing of the two tempering fluids is thereby controlled or regulated such, depending on a desired ink temperature (operating temperature or nominal temperature), as is required for an optimal print image for printing with the ink printer.

The temperatures of the tempering fluids can be brought to a corresponding desired temperature level, in the event that these do not already have such a temperature level upon being supplied/refilled into the respective fluid source 12, 14. In addition, the temperatures of the tempering fluids can be measured in the fluid sources 12, 13 themselves, and/or also on the way to the mixer 22 (along the fluid conduits 18) as well as at the inflows 20 of the mixer 22. For this purpose, temperature sensors 24 (also referred to as temperature probes) that respectively measure the temperatures of the fluid, preferably directly in the fluid, are arranged accordingly. The temperatures of the tempering fluids can alternatively or additionally be measured before or in the mixer 22 in order to rapidly and reliably achieve the mixing of the two tempering fluids for a desired mixture temperature. A temperature sensor 24 that records the mixture temperature can additionally also be arranged directly after the mixer 22.

One or more of the temperature values measured by the temperature sensors 24 can be used to control or regulate the desired ink temperature for printing of the ink, and for this are reported at the mixer 22 (the corresponding electrical lines or wireless connections are not shown in FIG. 1 for the sake of clarity).

The mixture having a required, desired, or sought mixture temperature is supplied to a heat exchanger 26. The heat exchanger 26 has a mixture circuit and an ink circuit. The mixture coming from the mixer 22 flows through the mixture circuit. And, the required ink coming from an ink reservoir 28 flows through the ink circuit. The two circuits are physically separated from one another, for example by a thermally conductive wall, cladding, or partition (not depicted in FIG. 1). The thermal energy of the mixture is transmitted via the wall to the ink of the ink circuit (thermal transfer always takes place from the warmer medium to the colder). Via corresponding control/regulation of the temperature of the mixture, as a result of the thermal transfer the ink is tempered in the heat exchanger 26 to a desired nominal temperature that is then necessary for printing in order to achieve a correspondingly good print quality of the print image.

The mixture is supplied to the heat exchanger 26, arriving from the mixer 22 via a mixture entrance 30, and is supplied back to one of the two fluid sources 12, 14, or to both fluid sources 12, 14, via a mixture exit 32 and via a fluid conduit 18 that serves as a return line.

The ink is supplied to the heat exchanger 26 via an ink conduit 33, an ink entrance 34, and tempered ink is supplied from an ink exit 36 to a printing unit 40 via an ink conduit 38. The ink can be supplied to the heat exchanger 26 via an ink reservoir 28 or a backpressure tank (not explicitly depicted in FIG. 1). The ink that is not consumed in printing can be returned to the ink reservoir 28, which is depicted in FIG. 1 by the dashed return line 29. Before the ink reaches the heat exchanger 26, it can already be pre-tempered in the ink reservoir 28, which leads to a faster regulation up to the operating temperature. Moreover, the ink can be degassed in a backpressure tank before the heat exchanger 26 and be brought to a corresponding hydraulic pressure, which in particular plays a large role in a good print quality.

The printing unit 40 can have a distribution tank 44 in which the supplied and tempered ink is buffered. The ink is supplied from the distribution tank 44 to one or more print heads 42, which then can print to a recording medium 46 (printing substrate). The distribution tank 44 can also be integrated on or into the housings of the print heads 42. A degassing device that degasses the ink (possibly additionally or anew) can also be comprised in the print heads 42. Alternatively or additionally, a temperature sensor can be integrated into the print heads 42.

A separate mixer 22, and a heat exchanger 26 connected therewith, is preferably present for each ink color. This means that a separate tempering device 10 is then respectively associated with printing unit 40, which tempering device 10 tempers the respective ink for the corresponding printing unit 40. It can also be that only two fluid sources 12, 14 are present for all ink colors. For each color, each mixer 22 is then fed from the two fluid sources 12, 13, and the respective ink is then tempered via each mixer 22 with subsequent heat exchanger 26. A single mixer 22 can also be connected with a plurality of heat exchangers 26 if the respective inks should be regulated to the same nominal temperature.

In this way, the tempering device 10 has two fluid circuits, and in fact one for the tempering fluids inclusive of the mixture and one for ink that is supplied to the printing unit 40 via the heat exchanger 26.

The warm fluid source 12 and the cold fluid source 14 can respectively have a container for the respective tempering fluid, in which container can be arranged a heating element 14 and/or cooling element 15 in order to set the desired temperature of the respective tempering fluid. Upon starting up the ink printer, the fluid temperature in the two fluid sources 12, 14 is set, and this temperature is largely maintained during the printing operation.

One or both fluid sources 12, 14 can be arranged in the housing of the ink printer. One or both fluid sources 12, 14 can also be arranged outside of the ink printer, wherein then the two tempering fluids are supplied separately from one another to the mixer 22 via corresponding fluid conduits 18.

Conventional heating elements, for example a heating coil that runs around a conduit and warms the fluid flowing through said conduit, or NTC thermistors that are arranged directly in the fluid, can be arranged as heating elements 13 and warm said fluid to a desired upper temperature. Conventional cooling elements, such as chillers, PTC thermistors, or cooling compressors can be used as cooling elements 15 that cools or tempers the cold fluid to a desired lower temperature.

Any suitable fluid, be it gas or a liquid, that can conduct the heat well upon transport—i.e., upon flowing—through corresponding conduits can be used as a tempering fluid. Water is preferably used, which is very environmentally compatible and sufficiently available. Defined additives or chemicals, such as fungicides or biocides, can be added to the water in order to prevent the possible effects that negatively affect the thermal conductivity, for example due to fungal infestation or algae.

The two fluid sources 12, 14 can also be fed by a separate domestic water connection of the operator at which the ink printer is situated. The drawn mains water (this can be the cold water connection and/or the warm water connection) can thereby be supplied via supply connections 21 to the fluid reservoirs 17, 19, or directly to the outflows 16 of the fluid sources 12, 14 (the external supply connections 21 for warm fluid and for cold fluid are represented by the dashed arrows). Water (tempering fluid) can thus be filled into the fluid reservoirs 17, 19 as needed or be refilled as needed, or can be conducted directly into the fluid conduits 18 in order to supply the already pre-tempered water to the mixer 22.

The temperatures of the tempering fluids are thereby set so that the warm fluid has an upper or warmer temperature and the cold fluid has a lower (colder) temperature. The two temperatures are chosen so that the desired nominal temperature of the ink is approximately, roughly in the middle of the two temperatures of the tempering fluids. The mixture temperature is then set via corresponding proportionate mixing of the two volumetric flows of the tempering fluids, if applicable also under consideration of their respective thermal capacities per volume. For this reason, the temperatures of the two tempering fluids do not need to be pre-adjusted as precisely, since the mixture temperature is subsequently accordingly regulated very precisely via a regulation with feedback of the measured ink temperature (real value) and a comparison with the desired operating temperature (nominal value).

This is very advantageous, for example if mains water from a domestic connection is used as a fluid source 12, 14.

If the operating temperature of the ink, as specified by the manufacturer of the ink, should be—for example—32° (ideal temperature of the ink as specified by the manufacturer to achieve an optimal print quality), the temperature of the warm fluid can, for example, be set to approximately 40° C., and the temperature of the cold fluid can be set to approximately 20° C. However, care is to be taken that the temperature of the warm fluid is not higher than the temperature that is the maximum permissible for the ink. The ink temperature thus cannot exceed this maximum permissible temperature, even given a failure of the regulation in the mixer 22, since the mixture is mixed from the two temperature fluids and, due to the mixing, the mixture temperature can never be higher than the preset temperature of the warm fluid.

Due to this large range between the warm temperature and the cold temperature, a maximally good spread is possible with which a flexible tempering device 10 is achieved with a large adjustment range for the nominal temperature of the ink. This means that the ink can be varied in terms of its temperature by the mixing, and therefore adjusted, in an optimally large range, depending on the requirement and specification, without the components of the tempering device 10 needing to be changed. Many different inks can thus be used with the tempering device 10.

The mixing of the two tempering fluids thereby depends on the mass throughput of the respective fluid and its temperature, wherein the desired resulting mixture temperature is regulated or controlled depending on the desired nominal temperature of the ink (by feeding back the real value of the measured ink temperature). The flow rate or mass throughput (also referred to as volumetric flow) depends on how much volume/quantity of the respective tempering fluid flow per time period through the mixing valves 50 of the mixer 22 in order to achieve the desired mixture temperature.

A controlled or regulated mixing of the two temperature fluids occurs in the mixer 22 in that a corresponding quantity of tempering fluids with the respective fluid temperature is respectively mixed via mixing valves 50 so that a desired mixing temperature is achieved at the output 17 of the mixer 22. For this purpose, a conventional mixing valve 50 (multiway valve) can be used having two inputs for the tempering fluids and at least one output for the mixture fluid. In such mixing valves 50, the input-side volumetric flows can be varied depending on the desired ratio so that the corresponding and desired mixture temperature is achieved at the output. The mixing can be performed by a control unit or a controller 52 depending on the measured temperature of the ink (real value) as a control variable, meaning that the mixing is dependent on the actual measured ink temperature at which the individual quantities of the two tempering fluids are then accordingly mixed.

A PI controller (proportional-integral controller) can preferably be used as a controller 52, as has long been known from control engineering. The controller 52 integrated into the control loop thereby acts on the mixing of the two tempering fluids so that the temperature of the ink that is to be regulated is adjusted, with the aid of the feedback of the measured temperature value of the ink, to the level of the desired nominal temperature of the ink. Of course, other suitable control units or controllers 52 can also be used in order to achieve the desired nominal temperature of the ink just before the printing unit 40.

For example, if the mixture temperature should be higher, the inflow quantity/fraction of warm fluid is increased and/or the inflow quantity of cold fluid is decreased by the mixer 22 (in particular by the controller 52). Conversely, if a lower mixture temperature is desired, the fraction/inflow quantity of the warm fluid is decreased and/or the fraction or the inflow quantity of cold fluid is increased. The temperature of the ink is thereby preferably measured after the ink exit 36 of the heat exchanger 26, and is fed back to the controller 52 for control or regulation. However, the flow path up to the print head 42 should then be relatively short, and the ink should not suffer too much heat loss along the way. Alternatively, the nominal temperature at the output of the heat exchanger 26 could be regulated higher by a correction factor in order to achieve the correct operating temperature of the ink at the print heads 42, depending on the thermal losses.

Alternatively, the mixture temperature at the output 17 of the mixer 22 can also be measured and fed back. However, a small thermal loss that is caused by the heat exchanger 26 must then be taken into account as well as a correction factor in order to regulate the real value to the nominal value (operating temperature) of the ink.

If the temperature of the ink is in general measured optimally close to the “consumption,” i.e. at the print head 42 or directly at the ink output of the heat exchanger 26 given a short flow path to the print head 42, the accuracy of the regulation is greatest. In order to provide ink at the nominal temperature for the printing unit 40, optimally without variation or with barely any variation, the conduit paths of the ink conduit 38 from the heat exchanger 26 to the printing unit 40, and there up to the print head 42, should be kept as short as possible, and preferably should be thermally insulated (for example, as given corresponding ink conduits 38 made of plastic). This means that the heat exchanger 26 should advantageously be arranged close to the printing unit 40. Otherwise, the actual thermal losses along the ink conduit would also need to be taken into account as a correction factor in the regulation of the nominal temperature. In such an event, the nominal temperature at the ink exit 36 of the heat exchanger 26 would need to be adjusted higher by the correction factor than the temperature of the ink that is actually required and desired in the printing unit 40.

The heat exchanger 26 (also referred to as a thermal transfer medium) is a device that transfers thermal energy from the mixture stream flowing through the heat exchanger 26 to the ink stream flowing through the heat exchanger 26. Two material streams (mixture and ink) thus flow through the heat exchanger 26 in order to bring one of the two material streams to a predetermined thermodynamic state as a result of heat exchange due to the other material stream. The thermal power emitted by the warmer stream (normally the mixture) and simultaneously absorbed by the colder stream (normally the ink) is used to temper the ink in terms of its temperature.

The thermal power emitted by the mixture stream and absorbed by the ink stream is thereby utilized in order to bring the temperature of the ink to a desired nominal value. The heat is thereby emitted by the warmer material flow and absorbed by the colder material flow. Both a warming and a cooling of the ink is thus possible, depending on the demand and temperature of the two material streams.

The heat exchanger 26 can be of numerous designs; the requirement is that two physically separate material streams (mixture and ink) are present via which thermal energy is transferred from one material stream to the other. The mixture stream can thus flow in the same direction as the ink stream or also opposite thereto (as is depicted in FIG. 1).

There is also the possibility that the material streams cross, or one material stream is directed in a helix around the other with the aid of a corresponding conduit. It is essential that the two material streams be physically (bodily) separated from one another by a wall or a corresponding dividing component having good thermal conductivity (thus are only in thermal contact, but not in direct contact), so that the ink is not contaminated or diluted by the mixture. The thermal transfer should also be optimally effective so that the temperature of the ink at the ink exit 36 of the heat exchanger 26 can be set as precisely as possible to the desired value (nominal temperature of the ink), even should only the mixture temperature at the output 17 of the mixer 22 be measured for the regulation and be fed back to the controller 52. However, the temperature of the ink is advantageously measured at the ink exit 36 of the heat exchanger 26, or even better afterward in the printing unit 40 or near the print heads 42.

The heat exchanger 26 is preferably designed as a plate heat exchanger in which the thermal energy is transferred via the wall having good thermal conductivity. The two material streams are thereby spatially separated by the heat-permeable wall. The wall or cladding that separates the two material streams should have a good thermal conductivity and a large surface area so that the thermal energy can be transferred as effectively as possible. The greater the design of the area of the plate, the more thermally conductive the wall between them, and the thinner the wall the more effective the thermal transfer.

The tempered ink is supplied to the printing unit 40 after the heat exchanger 26. This printing unit 40 can have a distribution tank 44 in which the ink is distributed to one or more print heads 42 with which this same ink is respectively printed. Distribution tank 44 and possible degassing unit (not shown) can also be arranged in the print head unit itself.

A separate tempering device 10 is provided for each print color (for example an ink with a defined color), which tempering device 10 then forwards the corresponding ink to the corresponding print heads 42 so that this color can also be printed with corresponding print heads 42. Each ink can typically have its own chemical composition, and thus its own nominal temperature at which the ink can be optimally printed.

The flow routes of the material streams (tempering fluid, mixture, ink) are predetermined by corresponding fluid conduits 18. The fluid conduits 18 can be tubular in design and consist of metal, plastic, or other suitable materials such as composites. The material streams thereby accordingly flow in the direction in the fluid conduits 18 as they are represented by the arrows in FIG. 1.

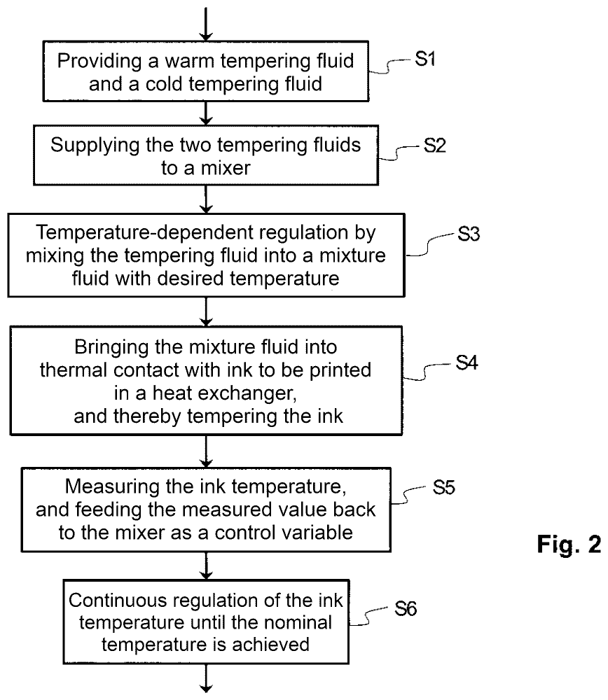

A workflow diagram of a method for operating a tempering device 10 as it has been described in conjunction with FIG. 1 is depicted in FIG. 2. First, in step S1 two tempering fluids with different temperatures are thereby provided, i.e. a warm fluid and a cold fluid. In step S2, these two tempering fluids are supplied to a mixer 22 that, via temperature-dependent regulation or control, (in step S3) mixes the fractions of the two different tempered tempering fluids into a mixture fluid having a desired temperature in order to ultimately therewith bring the ink to a nominal temperature.

In step S4, the mixture is supplied to a heat exchanger 26 where it is brought into thermal contact with an ink to be printed, which ink likewise flows through the heat exchanger 26. Thermal energy is thereby transferred from the mixture fluid to the ink, or in the reverse direction. In step S5, the ink temperature is subsequently measured and the measured value is fed back to the mixer 22 for regulation. There, in step S6 the ink temperature is then continuously regulated (meaning that the real value is measured, compared with the nominal value, and the ink is further tempered accordingly corresponding to the difference between nominal value and real value) until the nominal temperature of the ink is achieved and afterward is also largely maintained.

The ink is tempered via the thermal transfer from the mixture stream to the ink stream. The goal is to achieve a desired temperature of the ink at the exit from the heat exchanger 26, which desired temperature already corresponds to the nominal temperature or is close thereto. This is produced via a regulation in which the ink temperature is, for example, measured directly at the exit from the heat exchanger 26 or shortly thereafter and/or is measured at or in proximity to the print heads 42, and then is fed back as a real value to the mixer 22 for regulation. The mixture ratio of the two tempering fluids is subsequently controlled/regulated, i.e. varied, until the desired nominal temperature of the ink is actually achieved. Further regulation then continues so that the nominal temperature is also maintained. The temperature of the mixture can also be regulated via a mixing depending on the volumetric flows per time of the two tempering fluids, insofar as the temperatures of the two tempering fluids are known to the mixer.

Preferably, the actual printing is only begun when the ink temperature is regulated to operating temperature (within the tolerance range). The more rapidly this occurs, the more rapidly the printing can be started. If the printing has already begun, it may occur that the print quality is not yet acceptable.

With this tempering device 10, it is possible to adjust every nominal temperature of every print color, wherein only two tempering fluids at different temperatures are required on the input side. The accuracy of the temperature adjustment of the nominal temperature thereby depends essentially on the regulated mixing of the tempering fluids. The precise temperature level of the input-side fluid sources 12, 14 are of subordinate importance, since the actual precise temperature adjustment in the mixer 22 takes place via a control loop that is dependent on the measured real value and the difference of nominal value and real value of the ink. This means that the temperature level of the input-side fluid sources 12, 13 does not need to be as highly precise, and can even fluctuate slightly. In order to reduce the control demands, the temperature level of the fluid sources can already be stabilized to a largely constant value.

This manner of the two different tempered fluid sources 12, 14 has the advantage that the ink can be both heated and cooled. Assuming a middle value between the two fluid temperatures, upward and downward changes of the to-be-regulated temperature of the ink are both possible within a large variation range. However, the variation range corresponds to the temperature difference between the predetermined temperatures of the warm fluid and of the cold fluid. The ink can then be regulated only to a temperature that is between the warm temperature and the cold temperature.

Given this tempering device 10, it is advantageous that remaining ink that is not printed flows continuously through the ink circuit, from the ink reservoir 28, via the heat exchanger 26 and distribution tank 44, back to the ink reservoir 28 (circulation loop), so that the ink is continuously degassed in a device present in the entire circulation circuit, is kept largely at the same temperature level, and can be maintained under a predetermined hydraulic pressure, in order to achieve an optimal print result. If the temperature of the ink is already near the nominal temperature, for example in the ink reservoir 28, the control cost is significantly smaller. The printing can thus begin shortly without a long wait time or delay, since the ink temperature is already near the desired value.

However, the ink should have been brought to the corresponding nominal temperature before printing takes place, which can, however, be regulated relatively quickly via the tempering device 10. The control activity decreases afterward, since the ink only still needs to be maintained at the nominal temperature.

Backpressure tanks have long been known in digital ink printing. Therefore, these do not need to be discussed in detail here. A separate backpressure tank also does not necessarily need to be present; rather, its function can also be assumed by a corresponding device directly at the print heads 42. The unprinted ink also does not need to be returned to the ink reservoir 28, but rather can also be collected otherwise or be disposed of.

The temperature sensors 24 as such are sufficiently known. All suitable temperature sensor 24, such as NTC thermistors, PTC thermistors, thermocouples, Peltier elements etc. that supply an electrical signal as a measure of the temperature can be used to measure temperatures of fluids/inks. The temperature of a fluid/ink is preferably measured directly in the fluid/ink. If the temperature is measured from outside the fluid conduit 18, the measured value may deviate somewhat from the fluid temperature. A small correction thus would need to be performed in order to use the measured temperature for the regulation.

In the exemplary embodiment according to FIG. 1, the temperature of the ink is measured at the exit of the heat exchanger 26 or afterward, wherein the temperature sensor 24 measures the temperature most precisely directly within the fluid. The temperature of the ink can also be measured in the print heads 42. This has the advantage that the temperature is then measured where it is actually relevant. The regulation can thus be more precise. In all instances, a measured temperature value for regulating the ink temperature is fed back to the mixer 22, compared there with the nominal temperature, and the mixture of warm fluid and cold fluid is regulated accordingly (typically in numerous control passes).

The tempering device 10 according to the invention requires no separate warm or cool circuits; rather, a warm fluid source 12 and a cold fluid source 14 are present that respectively provide a tempering fluid (and, in fact, a warm fluid and a cold fluid) at respective predetermined temperatures. The two tempering fluids are then mixed according to quantity or fraction so that a mixture fluid with a desired mixture temperature is created. A temperature value of the ink, which is measured after the heat exchanger 26, preferably serves as a control variable. Additional temperature measurements of the mixture at the exit 17 of the mixer 22 are also possible to a limited extent. A temperature measurement directly before and/or directly in the printing unit 40 is particularly advantageous, wherein the measured values as control variable are returned or fed back to the mixer 22 for fractional mixing to regulate the ink temperature.

What are to be understood by the term “ink” are, in general, “print colors” that are colorant-containing mixtures and with which a printing substrate (recording medium 46) is printed to with the aid of print heads 42 to generate the print image, and therewith a print good. Water-based print colors such as aqueous inks are preferably used. However, other print colors that are not water-based may also be used.

The term “color” relates only to the actual color of the colorant, for example the colors YMCK (Yellow, Magenta, Cyan, Black that are often used in printing technology, or RGB (Red, Yellow, Blue) together with black.

The term “printing substrate” refers to the base material on which printing takes place. The printing substrate (or also referred to as a recording medium 46) can be comprised of paper, plastics (polymers), or other suitable materials or mixed materials.

Every ink has a specified operating temperature value that is provided by the manufacturer and represents the optimal temperature for the printing operation. This value can also be referred to as a nominal value. In the printing operation, the ink should be tempered to this value in order to achieve an optimal print quality of the print image. The manufacturer also specifies a narrow tolerance range within which an allowable deviation of the ink temperature is possible without there being losses in print quality. The ink should thus be tempered to the nominal value and also be maintained there (within the tolerance range) during the printing. Deviations within the tolerance range are harmless to the print quality. For example, the specified temperature value can be 32° C., with a tolerance range of approximately ±1° C.

In general, no damage to the ink should occur due to overheating or overcooling, not even if mixer 22 or heat exchanger 26 at least partially fail or are disrupted. The ink temperature is therefore achieved from a mixture of a warm fluid and a cold fluid. As a result of this, the ink temperature can never be heated to a higher temperature than the temperature of the warm fluid, and never be cooled to a lower temperature than the temperature of the cold fluid. In order to achieve an optimally wide (but not too large) variation range for the ink, the temperature of the warm fluid is predetermined at the maximum compatible temperature of the ink, and the temperature of the cold fluid is predetermined at the minimum compatible temperature of the ink. Given a specified nominal temperature of, for example, +32° C., the warm fluid can thus have a temperature of +40° C., for example, and the cold fluid can have a temperature of +20° C.

Printing units 40 of an ink printer are sufficiently known and do not need to be explained in detail here. For the invention, the manner of application of the ink and the type of the recording medium 46 play a subordinate role.

The PI controller (proportion-integral controller) consists of the parts of a P-element (proportional element) and an I-element (integral element), with a time constant. It can be defined both from a parallel structure or from a serial structure. Of course, other suitable controllers 52 or control units can also be used that, depending on the current real value of the ink temperature, control or regulate said ink temperature accordingly until a desired operating temperature/nominal temperature/nominal value of the ink is achieved.

A “fluid” is a comprehensive term for liquids, gases, and plasmas. A temperature can be transmitted by means of a fluid via thermal conduction. The volumetric flow (or flow rate/mass throughput) thereby indicates how much volume of a fluid is transported through a defined cross section per time period. By varying the volumetric flows of the two tempering fluids, a mixture with a desired resulting temperature can be achieved upon mixing. The volumetric flows can be varied as needed via corresponding controllable valves.

In FIG. 1, a tempering device 10 is depicted only for the color yellow (Y) with its distribution tank 44 (D_{Y}). The respective distribution tank 44 (here D_{M}, D_{C}, and D_{K}) with the associated supply conduits to the print bars (a plurality of print heads 42 in a row per color) are depicted only representatively for the other primary colors magenta (M), cyan (C), and black (K). Of course, printing can also be done with other primary colors such as RGB (red, yellow, blue, as well as black). Additional colors or other liquids, such as functional liquids, can likewise be printed with the print heads 42, wherein each ink has its own operating temperature at which it is optimally printed. Each of these inks thus has its own heat exchanger 26, since otherwise the inks would be mixed.

It is also very advantageous if only one mixer 22 is present per ink color. However, it is also possible to use a single mixer 22 for a plurality of heat exchangers 26 in the event that the same ink temperature is specified for the inks. For a precise regulation, it is advantageous if only a single control loop is present per color.

The composition of the inks and print colors themselves are of secondary priority for the invention, since it is essential that the aspect of the specified operating temperature of the liquid to be printed be complied with, independently of its chemical composition, even if the composition influences the specified temperature of the liquid to be printed.

Should the ink already be warmer than the mixture, the heat is transferred from the ink to the mixture and the ink temperature decreases (in the event that it was previously too high). In this way, the ink temperature can also be regulated in that the ink temperature is increased due to a higher temperature of the mixture, or the ink flow emits heat to the cooler mixture if the ink temperature is too high. The mixture temperature is thus continuously regulated, corresponding to the measured ink temperature, so that the desired temperature of the ink results after the heat exchanger 26.

The effectiveness of the heat exchanger 26 is dependent on the two entrance temperatures of ink and mixture, the transferred thermal power, and in particular on the flow configuration of both fluid streams through the heat exchanger 26, for example a parallel flow, a counter-flow, a cross-flow, or even a counter-flow vortex configuration. It is thereby essential that the thermal heat transfer occurs effectively and rapidly. The desired and specified nominal ink temperature can thus be achieved quickly and without large heat losses.

In order to achieve a better effectiveness, and to achieve a more rapid nominal temperature of the ink, the ink in the ink reservoir 28 can be roughly pre-tempered to a temperature near to the nominal temperature. If there is a large temperature difference between the ink temperature in the ink reservoir 28 and the nominal temperature of the ink at the ink exit 36 of the heat exchanger 26, the regulation to the nominal temperature takes significantly longer and is more expensive in terms of energy. However, the regulation then loses its variation range.

In addition to the material properties of the heat exchanger 26, the efficacy of the heat transfer is determined from the geometric configuration of the material streams with respect to one another.

Were the heat exchanger 26 to operate ideally, the efficiency of the heat transfer would thus be 100%. In this ideal case, the mixture temperature at the output of the mixer 22 is identical to the ink temperature at the output of the heat exchanger 26. It would then be the same if the mixture temperature or the ink temperature were measured and fed back as a control variable for the regulation. However, if the efficiency of the heat transfer is less than 100% (as is the case in reality), it is then more advantageous to measure the ink temperature after the exit from the heat exchanger 26 (i.e., directly before or in the printing unit 40, for example in the region of the print heads 42) and to feed this back as a real value in order to achieve a desired temperature value as a nominal value. The regulation of the ink temperature thus becomes more accurate.

By contrast, in the event that the mixture temperature is used as a control variable, a correction factor must be taken into account, given lower efficiency of the heat transfer, in order to compensate for this lower efficiency, meaning that the mixture temperature must then be set higher by this correction factor so that the desired ink temperature emerges. Both the mixture temperature and the ink temperature can thus be used as a control variable. However, the accuracy of the regulation is greatest if the ink temperature is measured optimally close to the “consumption” (i.e., near to the ejection of ink droplets by the print heads 42). The heat losses to the ink conduit to the print heads 42 then also have barely any influence on the accuracy. In the event that the ink temperature is measured directly after the heat exchanger 26, the ink conduits to the print head 42 must be relatively short so that the heat losses remain small and the tolerance range of the specified operating temperature of the ink is complied with.

The tempering device 10 thus has the advantage that a mixture from two tempering fluids at different temperatures serves to adjust the desired ink temperature. The ink temperature can thus never be higher than the temperature of the warm fluid, and never be lower than the temperature of the cold fluid. If the temperatures of warm fluid and cold fluid are set accordingly close to the maximum and minimum allowable ink temperature, a large variation range is created within which an operating temperature of the ink can be set. The heat exchanger 26 has the advantage that the mixture circuit is thermally connected with, but physically separate from, the ink circuit having the ink to be tempered. Although the ink thus cannot be diluted or contaminated by the mixture, it can be tempered simply and well.

### REFERENCE LIST

10 tempering device
12 warm fluid source
13 heating element
14 cold fluid source
15 cooling element
16 outflow
17 fluid reservoir (warm)
18 fluid conduit
19 fluid reservoir (cold)
20 inflow
21 supply connection
22 mixer
24 temperature sensor
26 heat exchanger
28 ink reservoir
29 return line
30 mixture entrance
32 mixture exit
33 ink conduit (before heat exchanger)
34 ink entrance
36 ink exit
38 ink conduit (after heat exchanger)
40 printing unit
42 print head
44, D_{Y}, D_{M}, D_{C}, D_{K} distribution tank
46 recording medium
50 mixing valve
52 controller
YMCK colors

1. A tempering device for tempering ink for an ink printer, having:
a warm fluid source with at least one outflow and at least one inflow, wherein a first tempering fluid with a warm fluid temperature is provided at the at least one outflow,
a cold fluid source with at least one outflow and at least one inflow, wherein a second tempering fluid with a cold fluid temperature is provided at the at least one outflow,
a mixer with at least two inflows that are connected via fluid conduits with the at least one output of the warm fluid source or the at least one output of the cold fluid source, at least one control unit that mixes mass throughputs of the supplied first and second tempering fluids in such a ratio that a mixture fluid with corresponding fractional quantities of the first and second tempering fluids is provided with a resulting mixture temperature at an output of the mixer,
a heat exchanger with a first fluid and a second fluid separate from one another for transferring thermal energy from the first fluid circuit to the second fluid circuit, with
a mixture entrance for the first fluid circuit, to which the mixture fluid is supplied from the mixer, and with a mixture exit of the first fluid circuit via which the mixture fluid is returned to the cold fluid source and/or the warm fluid source,
an ink entrance for the second fluid circuit, which is connected with an ink reservoir and via which ink to be tempered is supplied to the heat exchanger, and with an ink exit that is connected with at least one printing unit of the ink printer in order to supply the tempered ink to the at least one printing unit, and
a thermally conductive wall via which thermal energy is transferred from the one fluid circuit to the other, and
at least one temperature sensor that is arranged at or after the ink exit of the heat exchanger and is electrically connected with the mixer, wherein the temperature sensor measures a value of a temperature of the ink and feeds the measured value as a control variable back to the mixer in order to regulate a nominal temperature of the ink.

2. The tempering device according to claim 1, wherein the heat exchanger is a plate heat exchanger.

3. The tempering device according to claim 1, wherein the warm fluid source and the cold fluid source respectively have a heat generator and/or a cooling element via which the first and second tempering fluids are tempered to respective predetermined fluid temperatures.

4. The tempering device according to claim 1, wherein the first and second tempering fluids are water with possibly added additives.

5. The tempering device according to claim 4, wherein at least one of the warm fluid source and the cold fluid source are fed with a respective fluid temperature from one or more water conduits, which fluid temperatures correspond to a water temperatures of the water conduits.

6. The tempering device according to claim 1, wherein the warm fluid source and the cold fluid source respectively have one or more temperature sensors to measure respective fluid temperatures, wherein the one or more temperature sensors are electrically connected with the mixer in order to send the measured temperature values to the mixer.

7. The tempering device according to claim 1, wherein at least one temperature sensor that measures the temperature of the ink is arranged at the ink exit of the heat exchanger or in the printing unit.

8. The tempering device according to claim 1, in which the warm fluid and the cold fluid source respectively has one or more heating elements or cooling elements in order to set the warm fluid temperature to less than/equal to the maximum allowable ink temperature, and to set the cold fluid temperature so low that the predetermined mixture temperature is somewhere in a middle range between the two fluid temperatures, wherein the warm fluid temperature is preferably at approximately 40° C. and the cold fluid temperature is at approximately 20° C. if the ink temperature, according to a specified operating temperature value, is at approximately 32° C.

9. The tempering device according to claim 1, wherein the control unit of the mixer is a PI controller, connected upstream of which is a mixing valve in order to control the respective inflow quantity of the two tempering fluids such that the mixture fluid assumes the desired mixing temperature.

10. A method for tempering ink for an ink printer with a tempering device according to claim 1, the method comprising
providing the first tempering fluid with the warm fluid temperature and the second tempering fluid with the cold fluid temperature,
supplying the first and second tempering fluids to the mixer,
regulating the temperature of the mixture fluid in the mixer, which mixture fluid is mixed from corresponding fractions of the first and second tempering fluids depending on the measured ink temperature to achieve a desired mixture temperature at the output of the mixer,
bringing the mixture fluid into thermal contact with the ink, wherein the transfer of thermal energy from the mixture fluid to the ink to be printed is performed in the heat exchanger in order to bring the ink to the desired nominal temperature,
measuring the value of the ink temperature after an output of the heat exchanger, and feeding the measured value back to the mixer to regulate the ink temperature, and
continuously regulating the temperature of the ink until the nominal temperature of the ink is achieved and is subsequently largely maintained.
